(19) United States
(12) Patent Application Publication
(10) Pub. No.: US 2007/0040108 A1
(43) Pub. Date: Feb. 22, 2007

(54) Optical sensor light switch

(76) Inventor: John S. Wenstrand, Menlo Park, CA (US)

Correspondence Address: AVAGO TECHNOLOGIES, LTD., P.O. BOX 1920, DENVER, CO, 80201-1920, US

(21) Appl. No.: 11/204,508

(22) Filed: Aug. 16, 2005

(51) Int. Cl. G01J 1/36; G06M 7/00

(52) U.S. Cl. 250/221; 250/227.22

(57) ABSTRACT

A switch for controlling a lighting device includes a contact surface, a light source, and an optical navigation sensor. The contact surface includes a generally transparent zone and is configured for removably receiving a fingertip adjacent to the transparent zone. The light source is configured to illuminate the transparent zone of the contact surface. The optical navigation sensor is configured to sense relative motion of the illuminated fingertip at the transparent zone to modify a function of a lighting device external to the light switch based on the relative motion.

### BACKGROUND

Virtually everyone has experienced the- dissatisfaction of being in a room where the lighting is too bright for the intended use of the room. On the other hand, having no lighting in the room makes the room unusable. One conventional approach to this situation is to install a dimmer switch which enables an intensity of the room lighting to be varied to a desired intensity. Conventional dimmer switches typically include some form of circuitry to adjust the voltage supplied to the lamp. In one example, a circuit known as a bidirectional thyristor (e.g., a silicon-controller rectifier) is used to vary the voltage by controlling alternating current waveforms. A bidirectional thyristor circuit is frequently referred to as a TRIAC.

There are many obstacles to effective operation of a dimmer switch including radio frequency interference, power harmonics, heat, as well as the non-linear current demands for incandescent light bulbs. Other problems include buzzing associated with the dimmer as well as difficulty in smoothly changing the intensity of the light.

A typical dimmer switch includes a rotatable knob as part of a rheostat or a slide switch juxtaposed with a conventional rocker on/off switch. Each of these types of switches includes moving parts, which are subject to failure and add to the cost of the switch. Moreover, conventional wall-mounted switches are typically unattractive, but are tolerated because of the function they provide.

Given the desirability of dimming lights and the relative complexity of conventional light dimmers, more attractive and effective dimmer switches are still sought by consumers and designers alike.

### SUMMARY

Embodiments of the invention are directed to a switch for controlling a lighting device. In one embodiment, the switch comprises a contact surface, a light source, and an optical navigation sensor. The contact surface includes a generally transparent zone and is configured for removably receiving a fingertip adjacent to the transparent zone. The light source is configured to illuminate the transparent zone of the contact surface. The optical navigation sensor is configured to sense relative motion of the illuminated fingertip at the transparent zone to modify a function of a lighting device external to the light switch based on the relative motion.

### BRIEF DESCRIPTION OF THE DRAWINGS

FIG. 1 is a plan view of an optical switch for controlling a lighting device according to an embodiment of the invention.

FIG. 2 is an illustration of an optical switch, according to an embodiment of the present invention.

FIG. 3 is a partial sectional view illustrating an optical switch, according to an embodiment of the present invention.

FIG. 4 is a partial sectional view illustrating an optical switch, according to an embodiment of the present invention.

FIG. 5 is a partial sectional view illustrating an optical switch, according to an embodiment of the present invention.

FIG. 6 is a flow diagram illustrating a method of controlling a lighting device with an optical switch, according to an embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

Embodiments of the invention are directed to controlling a lighting device with an optical switch having no moving parts and that enables use of a fingertip to turn the lighting device on or off, and to dim the lighting device. By merely sliding a fingertip upward across a face of the optical switch, light emitted from the lighting device becomes brighter. By sliding the fingertip downward across the face of the optical switch, light emitted from the lighting device is dimmed. Accordingly, the optical switch enables intuitive use of the fingertip to either turn the lights up or turn the lights down.

The optical switch enables these functions by including a generally transparent zone in a contact surface (e.g., face) of the optical switch. Light is directed from an internal light source of the optical switch to illuminate the transparent zone and a fingertip, if present, at the transparent zone. A sensor module within the optical switch detects relative motion of an illuminated fingertip at the transparent zone, to translate the movement of the fingertip into a corresponding function (e.g., brighter, dimmer) of a lighting device. By detecting a presence or absence of the fingertip at the transparent zone, via the sensor module, the optical switch also controls an on/off state of the lighting device, as further described below.

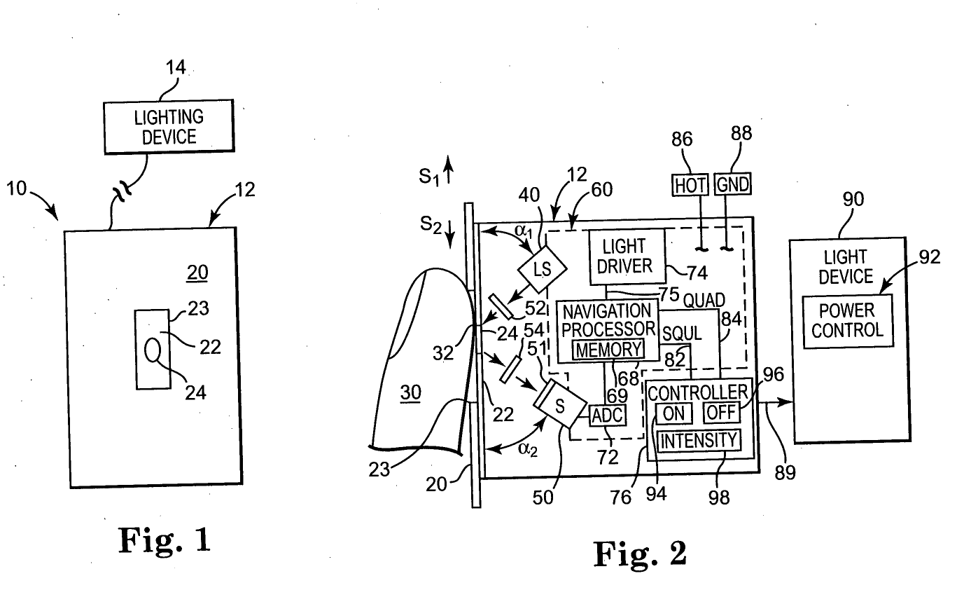

Examples of an optical switch according to embodiments of the invention are described and illustrated in association with FIGS. 1-6.

FIG. 1 is a diagram illustrating a lighting system 10 including lighting device 14 controlled by optical switch 12, according to an embodiment of the invention. As shown in FIG. 1, optical switch 12 comprises face 20 (e.g., wall plate) and contact surface portion 22. The contact surface portion 22 is defined by edge 23 and includes generally transparent zone 24. Contact surface portion 22 is sized and shaped to slidably receive a fingertip. In one embodiment; contact surface portion 22 is flush with surrounding portions of face 20. In other embodiments, contact surface portion 22 is recessed relative surrounding portions of face 20.

In one embodiment, light device 14 comprises an AC powered lamp having one or more light bulbs. In one aspect, each light bulb is an incandescent light bulb.

FIG. 2 is a block diagram illustrating components an optical switch 12, according to one embodiment of the invention. As shown in FIG. 2, in one embodiment, optical switch 12 comprises light source 40, sensor module 50 including photodetector array 51, focusing lens 52 and imaging lens 54. In operation, according to one embodiment, light source 40 emits light (A) through transparent zone 24 of contact surface portion 22 to illuminate surface 32 of fingertip 30 and thereby produce reflected and scattered light from illuminated fingertip surface 32. Imaging lens 54 acts to focus light that is reflected and/or scattered at fingertip surface 32 onto photodetector array 51 of sensor module 50.

In one embodiment, light source 40 is generally positioned so that light from light source 40 travels along a path (A) at a first angle (α₁) to contact surface 22 to enhance scattering, absorption, etc. of light to highlight spectral features of fingertip surface 32. In one embodiment, imaging lens 54 and sensor module 50 are positioned to receive the reflected light that travels along a path B at a second angle (α₂) relative to contact surface 22. In one aspect, the first angle and the second angle are substantially the same. In another aspect, imaging lens 54 and sensor module 50 are positioned so that reflected light travels along path B generally perpendicular to surface 22 with the second angle (α₂) being about 90 degrees relative to contact surface 22. Optical effects reflected from fingertip surface 32, in response to illumination from light source 40, are received at sensor module 50 (via photodetector array 51) and processed to form a digital representation of the imaged fingertip surface 32, as described below in further detail.

In one embodiment, sensor module 50 and light source 40 form a portion of navigation sensor integrated circuit (IC) 60. As shown in FIG. 1, optical navigation sensor circuit 60 includes navigation processor 68, analog to digital converter (ADC) 72, sensor module 50, and light source driver circuit 74. In one embodiment, navigation processor 68 also comprises digital input/output circuitry. In one embodiment, photodetector array 51 of sensor module 50 comprises a complimentary metal oxide semiconductor (CMOS) device or a charge coupled device (CCD).

In one embodiment, via photodetector array 51, sensor module 50 provides signals that vary in magnitude based upon the intensity of light incident on the sensor module 50. The signals from sensor module 50 are output to analog to digital converter (ADC) 72, which converts the signals into digital values of a suitable resolution. The digital values generated by analog to digital converter (ADC) 72 are output to navigation processor 68, which are stored as a frame within memory 69.

Different frames of varying light patterns detected via sensor module 50 are compared over time to generate movement information regarding movement of fingertip 30 (that causes the varying reflected light patterns). In one aspect, successive frames are compared while in other aspects, non-sequential frames are compared.

Various functions performed by sensor module 50 and navigation sensor circuit 60 (FIG. 1) may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory

In one embodiment, light source 40 is a generally incoherent light source such as a conventional light emitting diode (LED) of the type used in optical navigation systems. In another embodiment, light source 40 is a substantially coherent light source. In one embodiment, light source 40 is a laser. In one form of the invention, light source 40 is a vertical cavity surface emitting laser (VCSEL) diode. In another form of the invention, light source 40 is an edge emitting laser diode.

Light source 40 is controlled by driver circuit 74, which is controlled by navigation processor 68 via control line 75. In one embodiment, control line 75 is used by navigation processor 68 to cause driver circuit 74 to be powered on and off, and correspondingly cause light source 40 to be powered on and off.

Power line 86 and ground line 88 represent connectable elements of optical switch 12 for connection to a power source and ground reference of a power supply associated with lighting device 90.

Output from navigation processor 68 includes, among other components, a surface quality (SQUAL) output signal 82 and a quadrature output signal 84, which are both in electrical communication with a-controller 76. Controller 76 is configured to produce a power control signal 89 in response to the surface quality output signal 82 and quadrature output signal 84. Controller 76 is configured to use information obtained via the quadrature output signal 84 and the surface quality output signal 82 to determine an intended on/off state for lighting device 90, as well as the determine an intensity level for lighting device 90. In particular, on parameter 94, off parameter 96, and intensity parameter 98 form components of power control signal 89 to thereby drive a state of lighting device 90 (e.g. on, off, increased intensity, decreased intensity) as represented by power state parameter 92 of lighting device 90.

By comparing images of an illuminated fingertip 30 (at transparent zone 24) as fingertip 30 is moved (e.g. lateral sliding movement) along direction S₁, navigation sensor circuit 60 generates movement information to controller 76 to enable increasing or decreasing an intensity of light emitted from lighting device 90. As fingertip 30 is moved along contact surface portion 22 with fingertip 30 in a first direction (S₁), navigation processor 68 produces a corresponding signal of movement information to controller 76, which then causes (via intensity parameter 98) power state 92 of lighting device 90 to increase in intensity to brighten light emitted by lighting device 90. As fingertip 30 is moved along contact surface portion 22 with fingertip 30 moving in a second direction (S₂) opposite the first direction, navigation processor 68 produces a corresponding signal of movement information to controller 76, which then causes (via intensity parameter 98) power state 92 of lighting device 90 to decrease in intensity to dim the light emitted by lighting device 90.

In one aspect, the first direction (S1) corresponds to an upward motion of fingertip 30 and the second direction (S2) corresponds to a downward motion of fingertip 30. This arrangement enables intuitive use of an optical switch having no moving parts, since an individual would naturally move their finger upward to brighten a lighting device (e.g., “turn the lights up”) and move their fingers downward to dim a lighting device (e.g., “turn the lights down”).

In one embodiment, controller 76 includes a memory that saves a last “dimmed” setting of lighting device via intensity parameter 98, so when lighting device 90 is reactivated to an “on state” from an “off state”, lighting device 90 is activated to operate at its most recent intensity level. In this way, optical switch 12 mimics a feature of one form of an electromechanical dimmer switch in which a position of a slide (separate from an on/off lever) “remembers” the most recent “dimmer” setting based on a physical position of the slide switch or rotatable knob. In other embodiments, controller 76 is configured to cause reactivation of lighting device 90 at a full intensity each time the lighting device 90 is reactivated, or reactivated at a default dimmed intensity setting set within controller 76 by the manufacturer of optical switch 12.

In another aspect, the presence or absence of fingertip 30 is detected via navigation processor circuit 60 to enable controller 76 to initiate light emissions (e.g., turn light on) or terminate light emissions (e.g., turn light off) from lighting device 90. For example, when no fingertip 30 is present at transparent zone 24, then no reflected light is returned to sensor module 50, thereby producing information (via navigation processor 68) to controller 76 to maintain a current power state 92 of lighting device 90. On the other hand, when a fingertip 30 is introduced at transparent zone 24, sensor module 50 detects a change that reflected light is now present, thereby producing information (via navigation processor 68) to controller 76 to alter a power state of 92 of lighting device 90. Upon each instance of the renewed presence of fingertip 30 (after some period of absence), the power state 92 of lighting device 90 is changed between an on state and an off state, respectively, via signal 89 from controller 76.

In one aspect, memory 69 of navigation processor 68 stores a threshold value for the intensity of reflected light. The threshold value is less than the intensity of light reflected from a fingertip 30 (when illuminated by light source 40 at transparent zone 24) to enable distinguishing a fingertip, associated with an intended change in power state of lighting device 90, from other objects (e.g., dirt, bugs, etc.) that could be present adjacent transparent zone 24. Accordingly, a bug flying or landing at transparent zone 24 will not trigger a change in the on/off state of lighting device 90, nor a change in its intensity, since navigation processor 68 will not produce movement information to controller 76 unless the images and/or relative motion detected via sensor module 50 produces an intensity of reflected light that exceeds the threshold value for reflected light. However, when a fingertip 30 is present at transparent zone 24 (to change an on/off state or to change an intensity of lighting), the intensity of light reflected from fingertip 30 will exceed the stored threshold value and navigation processor 68 enables movement information to pass onto controller 76 to enable a change in the power state (e.g., on/off or intensity) of lighting device 90.

In one embodiment, light source 40 produces invisible light (e.g. infrared light) so that any light emitted from light source 40 through transparent zone 24 into a surrounding environment is not seen by individuals in the surrounding environment. In this manner, the light switch 12 avoids introducing visible light into the surrounding environment that detracts from the ambience of the surrounding environment. Of course, in a manner known to those skilled in the art, the invisible light produces reflected light for detection by the optical navigation sensor circuit 60.

In another embodiment, light source 40 produces visible light (such as red light). In a first mode, via management by controller 76 and/or navigation processor 68, light source 40 is configured to produce a first intensity of light from light source 40 that is sufficient to minimally illuminate transparent zone 24 with just enough light to enable an individual to identify a location of light switch 12 in a dark room (or merely for decorative purposes) and to allow the navigation processor to detect the presence of a fingertip. In a second mode, via management by controller 76 and/or navigation processor 68, light source 40 is configured to produce a second intensity of light from light source 40 with an intensity sufficient to perform optical navigation sensing (to enable controlling an intensity of light from lighting device 90). In one embodiment, the second intensity of light is substantially higher than the first intensity of light.

In one aspect, the intensity of light produced by light source 40 is sufficient in the first mode or the second mode to enable detection of the presence or absence of fingertip 30 relative to transparent zone 24. Accordingly, during the absence of fingertip 30 from transparent zone, the light source 40 will remain in the first mode of minimal illumination. However, the presence of fingertip 30 will trigger a change from the first mode to the second mode of full illumination to enable changing a power state of lighting device 90.

In another aspect, the operation of light source 40 in the first mode or the second mode is independent from whether the lighting device 90 has a power “on” state or a power “off” state. In other words, after the lighting device 90 has been turned on and fingertip 30 is removed from transparent zone 24, light source 40 will enter the first mode of minimal illumination. Likewise, after the lighting device 90 has been turned off and fingertip 30 is removed from transparent zone 24, light source 40 also will enter the first mode of minimal illumination. Accordingly, whether the lighting device 90 is a power on state or a power off state, upon the absence of fingertip 30 from transparent zone 24 of light switch 12, light source 40 will operate in the first mode of minimal illumination.

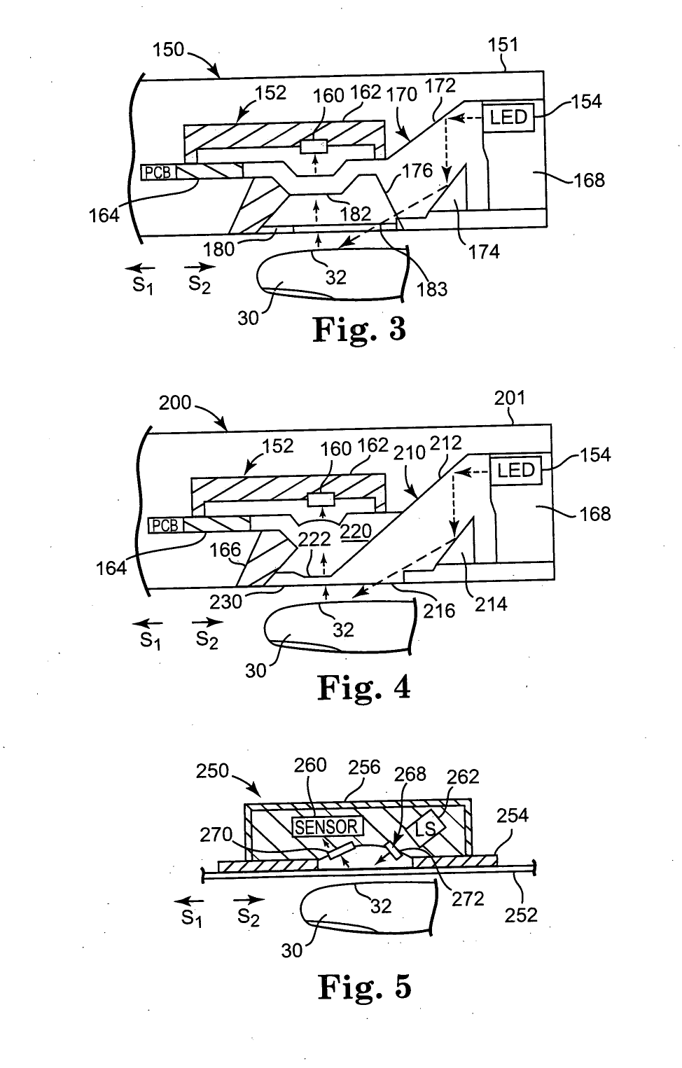

FIG. 3 is a partial sectional view illustrating an optical switch 150, according to an embodiment of the invention. Optical switch 150 comprises a switch device that enables tracking motion of finger tip 32, as shown in FIG. 3. In one embodiment, optical switch 150 comprises substantially the same features and attributes as optical switch 12 regarding controlling a lighting device, as previously described in association with FIG. 1, as well as additional features described and illustrated in association with FIGS. 3.

As shown in FIG. 3, optical switch 150 comprises sensor module 150, light source 154, and lens structure 170. In one aspect, sensor module 150 and light source 154 operate in a manner substantially the same as sensor module 50 and light source 40 of FIG. 2 (and are operably supported by substantially the same components present in optical switch 12) to convert movement of a fingertip at optical switch 150 into a changed power state of a lighting device, such as lighting device 14, 90 (FIGS. 1 and 2). Lens structure 170 directs and conditions light from light source 154 to be emitted toward and through transparent zone 183 of a finger contact portion 180. In one aspect, lens structure 170 comprises a prism 172 for directing emitted light along its intended path to transparent zone 183. In another aspect, lens structure 170 comprises imaging lens portion 182 configured with a size, shape and position to image reflected light from fingertip 30 at photodetector array 160 of sensor module 152. Photodetector array 160 is formed as part of navigation sensor integrated circuit 162 secured to a printed circuit board 164 to position photodetector array 160 to receive reflected light from illuminated fingertip 30. Navigation processor circuit 162 comprises substantially the same features and attributes as navigation sensor circuit 60 (FIG. 2), and is also in communication with a controller, such as controller 76 of optical switch 12.

In one embodiment, as shown in FIG. 3, light source 154 is secured relative to a support 168 and support 166 also partially supports lens structure 170. Moreover, in one embodiment, the components of optical switch 150 are contained within a housing 151 suitable for installation within a wall or other receptacle to enable mounting the contact portion 180 at a surface of a wall or at a surface of another structure.

As shown in FIG. 3, contact portion 180 is secured to housing 151 separately from lens structure 170, being generally spaced from surface 176 of lens prism 172. This arrangement enables optical switch 150 to be manufactured in separate components and then assembled into a single switch assembly. This arrangement also enables use of different contact portions members 180, such as different colors, sizes, etc. to suit the environment in which optical switch 150 is installed.

FIG. 4 is a partial sectional view illustrating an optical switch 200, according to an embodiment of the invention. Optical switch 200 comprises a switch device that enables tracking motion of finger tip 32, as shown in FIG. 4. In one embodiment, optical switch 200 comprises substantially the same features and attributes as optical switches 12, 150 regarding controlling a lighting device, as previously described in association with FIGS. 1 and 3, except for having a different lens structure 210 instead of lens structure 170.

As shown in FIG. 4, optical switch 200 comprises sensor module 152, light source 154, and lens structure 210. Lens structure 210 directs and conditions light from light source 154 to be emitted toward and through transparent zone 216 of contact member 230. In one aspect, lens structure 210 comprises a prism 212 for directing emitted light along its intended path to transparent zone 216. In another aspect, lens structure 210 comprises imaging lens portion 220 configured with a size, shape and position to image reflected light from fingertip 30 at photodetector array 160 of sensor module 152. Photodetector array 160 is formed as part of navigation sensor integrated circuit 162 secured to a printed circuit board 164 to position photodetector array 160 to receive reflected light from illuminated fingertip 30.

In one embodiment, light source 154 is secured relative to a support 168 and support 166 also partially supports lens structure 210. Moreover, in one embodiment, the components of optical switch 200 are contained within a housing 201 suitable for installation within a wall or other receptacle to enable mounting the contact member 230 at a surface of a wall or at a surface of another structure.

As shown in FIG. 4, contact member 230 is part of and extends from prism 212 that defines lens structure 210. This arrangement enables optical switch 200 to be manufactured or molded as a single piece by integrating the prism 212 that acts as a focusing lens for light source 154 with the generally transparent window (i.e., transparent zone 216 of contact member 230) through which the emitted light must pass for illuminating fingertip surface 32. This arrangement simplifies assembly of optical switch 200, because fewer parts are handled and because the optical characteristics of prism 212 and transparent window 216 of contact member 230 are naturally harmonized by formation as a single component.

FIG. 5 is a partial sectional view illustrating an optical switch 250, according to an embodiment of the invention. Optical switch 250 comprises a switch device that enables tracking motion of finger tip 32, as shown in FIG. 5. In one embodiment, optical switch 250 comprises substantially the same features and attributes as optical switch 12 regarding controlling a lighting device, as previously described in association with FIG. 1, as well as additional features described and illustrated in association with FIGS. 5.

As shown in FIG. 5, optical switch 250 comprises a contact member 252 and a navigation sensor integrated circuit 256 arranged as a DIP (dual inline package) or other modular configuration. In one embodiment, package 256 is mechanically connected to contact member 252 to enable mounting contact member 252 flush with a wall (or other structure) so that package 256 positioned behind the wall via contact member 252.

In one embodiment, navigation sensor circuit 256 comprises sensor module 260, light source 262, and lens structure 268, which includes focusing lens 272 and imaging lens 270. Sensor module 260 and light source 262 operate in a manner substantially the same as sensor module 50 and light source 40 of FIG. 1 (and are operably supported by substantially the same components present in optical switch 12) to convert movement of fingertip 30 at optical switch 250 into a changed power state of a lighting device, such as lighting device 14, 90 (FIGS. 1 and 2). Accordingly, other than the generally transparent zone 253 of contact member 252, navigation sensor circuit 256 comprises a comprehensive navigation sensor and light source 262 enclosed within a single package. Accordingly, optical switch 250 enables quick and easy installation because package 256 is relatively small to enable substantially the entire package (at least including the major components of the light source and sensor module) to be positioned in immediate proximity of the generally transparent zone 253 by merely electrically and mechanically securing package in its operable position relative to contact member 252.

In another embodiment, transparent zone 253 (and contact member 252) are formed as a part of navigation sensor package 256 so that entire assembly is installable at a surface of a structure.

Lens structure 268 includes focusing lens 272 and imaging lens 270 to direct and condition light from light source 262 and into sensor module 260. In one aspect, lens structure 268 comprises a focusing lens 272 for directing emitted light along its intended path toward and through transparent zone 253 of contact member 252. In another aspect, lens structure 268 comprises imaging lens 270 is configured with a size, shape and position to image reflected light from fingertip 30 at a photodetector array of sensor module 260.

In use, optical switch 250 operates in a manner substantially the same as optical switch 12 (FIG. 2) to enable fingertip control of a power state of a lighting device, including turning the lighting device on or off and varying its intensity.

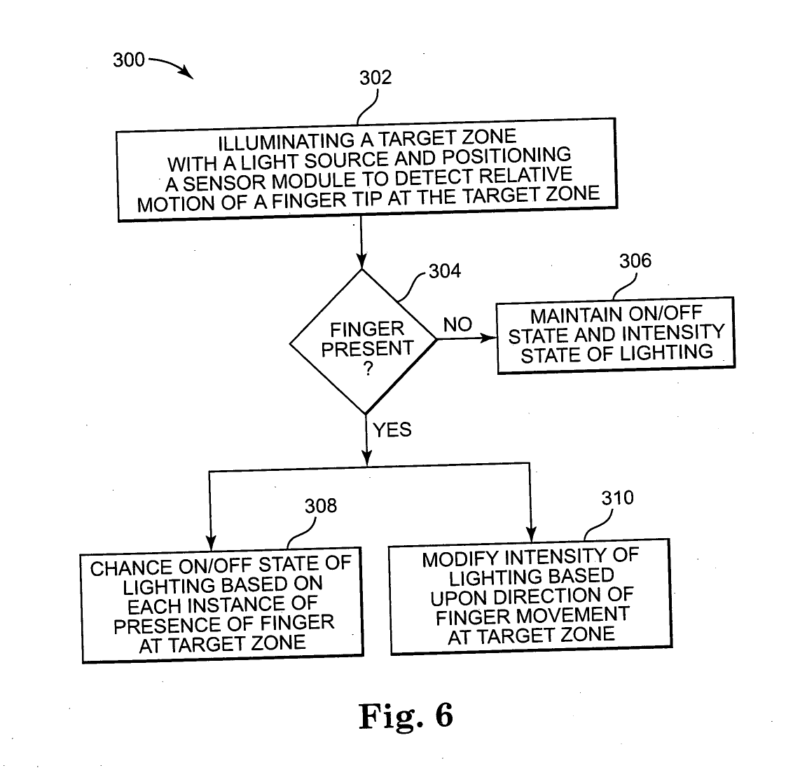

FIG. 6 illustrates a method 300 of controlling a lighting device via an optical switch, according to an embodiment of the invention. As shown in FIG. 3, at 302, a light source of the optical switch illuminates a translucent target zone adjacent an exterior surface of the optical switch and a sensor module of the optical switch is positioned to detect relative motion of a finger tip adjacent the illuminated translucent target zone of the optical switch.

At 304, the sensor module detects whether the fingertip is present at the translucent target zone. If no fingertip is present, then at 306 an on state or an off state, respectively, of the lighting device is maintained. If a fingertip is present adjacent translucent target zone of the optical switch, then at 308 an on state or an off state of the lighting device is changed to the opposite respective state (e.g. from an on state to an off state, or from an off state to an on state). As long as the fingertip remains at the translucent target zone, the current on state or off state is maintained. However, upon each instance that fingertip is reintroduced at the translucent target zone, then the on/off state of the lighting device is changed.

At 310, once a fingertip is present at the translucent target zone and the lighting device is in an on state, then sliding movement of the fingertip relative to the illuminated translucent target zone causes an additional change in the function of the lighting device based upon that sliding movement of the illuminated fingertip. In one aspect, sliding movement of the illuminated fingertip at translucent target zone causes the intensity of light emitted from the lighting device to be modified in accordance with a direction of the movement of fingertip. In one aspect, moving a fingertip in a first direction (e.g. upward) relative to the translucent target zone, causes an intensity of light emitted from lighting device to increase (i.e., the light gets brighter). In another aspect, moving a fingertip in a second direction (e.g., downward) opposite the first direction relative to the translucent target zone, causes an intensity of light emitted from the lighting device to decrease (i.e., the light gets dimmer).

In another embodiment, the control signals are reversed so that movement of the fingertip in the first direction causes a decrease in light intensity of the lighting device while movement of the fingertip in the second direction causes an increase in light intensity of the lighting device.

In addition, in other embodiments, a sliding movement of an illuminated fingertip at the translucent target zone causes a change in a value of other functions of a lighting device. In one aspect, these other functions include, but are not limited to, changing a color of light emitted from a bank of light bulbs of a lighting device or changing a pattern of light emitted from a bank of light bulbs of a lighting device by varying the power supplied to different respective light bulbs in the bank of light bulbs.

In one embodiment, method 300 is performed using optical switch 12 as previously described and illustrated in association with FIG. 1, and as well as any one of optical switches 150, 200, 250 as described in association with FIGS. 3-5, respectively.

Embodiments of the invention are directed to an optical switch that enables controlling a lighting device including turning the lighting device on and off, as well as increasing or decreasing the intensity of light emitted from the lighting device. In one aspect, motion of a finger (that is illuminated by a light source of the optical switch) relative to a sensor module of the optical switch enables generating a corresponding power signal to the lighting device to increase or decrease the intensity of the light based on a direction of the relative motion of the fingertip.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A switch for controlling a lighting device, the switch comprising:
a contact surface including a generally transparent zone and configured for removably receiving a fingertip adjacent to the transparent zone;
a light source configured to illuminate the transparent zone of the contact surface; and
an optical navigation sensor configured to sense relative motion of the illuminated fingertip via the transparent zone to control a function of a lighting device external to the light switch based on the relative motion.

2. The switch of claim 1 wherein the relative motion is a sliding movement of the fingertip across the transparent zone of the contact surface and wherein the optical navigation sensor comprises a navigation processor configured to generate movement information based on the relative motion to control an intensity of light emitted by the lighting device including:
directing an increase in the intensity of the light from the lighting device based on the sliding movement of the fingertip relative to the transparent zone in a first direction; and
directing a decrease in the intensity of the light from the lighting device
based on the sliding movement of the fingertip relative to the transparent zone in a second direction generally opposite the first direction.

3. The switch of claim 2 wherein the navigation processor is configured to initiate and terminate, respectively, the light emitted from the lighting device based each instance of a presence of the fingertip relative to the transparent zone of the contact surface.

4. The switch of claim 2 wherein the optical navigation sensor comprises a switch controller in communication with the navigation processor and configured to send a power signal, based on the generated movement information, to the lighting device to control the intensity of light emitted by the lighting device.

5. The switch of claim 4 wherein the navigation processor is configured to store a threshold value of reflected light and is configured to provide the generated movement information to the switch controller only when an intensity of reflected light from the illuminated fingertip exceeds the threshold value of reflected light.

6. The switch of claim 1 wherein the light source comprises a lens member disposed between the light source and the transparent zone wherein the lens member is generally spaced apart from the transparent zone of the contact surface.

7. The switch of claim 1 wherein the light source comprises a lens member disposed between the light source and the transparent zone wherein the transparent zone of the contact surface forms a portion of and extends from the lens member.

8. The switch of claim 1 and further comprising:
an integrated circuit package configured to enclose and arrange the light source and the optical navigation sensor to enable illuminating the fingertip and sensing the relative motion of the fingertip, respectively, from within the integrated circuit package.

9. The switch of claim 1 and further comprising:
a wall plate for defining the contact surface; and
a switch housing for enclosing the light source and the sensor module and being configured for removably coupling relative to the wall plate.

10. The switch of claim 1 wherein the light source illuminates the transparent zone with a visible light, and wherein in a first mode, the light source emits the visible light at a first intensity level to enable minimal illumination of the transparent zone and in a second mode, the light source emits the visible light at a second intensity level substantially higher than the first intensity level to enable operation of the optical navigation sensor to detect the relative motion, wherein the light source operates in the first mode upon absence of a fingertip relative to the transparent zone and the light source operates in the second mode upon the presence of a fingertip adjacent the transparent zone.

11. The switch of claim 1 wherein the light source illuminates the transparent zone with an invisible, infrared light.

12. A lighting device comprising:
a light bulb configured to emit environmental light;
a switch in electrical communication with the light bulb and including:
a finger contact member including a generally translucent portion;
a light source arranged within a housing of the switch to illuminate a fingertip through the generally translucent portion of the finger contact member; and
an optical navigation sensor arranged within the housing of the switch to detect relative sliding motion of the illuminated fingertip adjacent the generally translucent portion, the optical navigation sensor including a power controller configured to control a function of the light bulb based upon the relative sliding motion of the fingertip.

13. The lighting device of claim 12 wherein the power controller is configured to control a function of the light bulb by increasing a volume of the environmental light emitted from the light bulb upon the relative sliding motion being movement of the fingertip in a first direction and decreasing the volume of the environmental light emitted from the light bulb upon the relative sliding motion being movement of the fingertip in a second direction, the second direction being generally opposite to and generally parallel to the first direction.

14. The lighting device of claim 13 wherein the power controller is configured to control a function of the light bulb by causing the light bulb to alternately terminate emission of the environmental light from the light bulb and initiate emission of the environmental light from the light bulb based upon each separate instance of a presence of the fingertip at the generally translucent portion of the finger contact member.

15. A method of controlling a lighting device, the method comprising:
establishing electrical communication between an optical switch and a lighting device;
producing illumination, via a light source in a housing of the optical switch, of a fingertip at a generally transparent opening of the housing; and
sensing, via a sensor module in the housing of the optical switch, lateral sliding movement of the illuminated fingertip adjacent to the transparent opening as relative motion to control a function of the lighting device.

16. The method of claim 15 wherein modifying a function of the light comprises:
increasing an intensity of the light emitted from the lighting device as the illuminated fingertip is moved in a first direction of the lateral sliding movement relative to the transparent opening of the housing; and
decreasing the intensity of the light emitted from the lighting device as the illuminated fingertip is moved in a second direction of the lateral sliding movement relative to the transparent opening of the housing, the second direction being generally opposite to the first direction.

17. The method of claim 15 wherein producing illumination of a fingertip comprises:
arranging the transparent opening as a translucent member extending across the transparent opening; and
disposing a lens between the light source and the translucent member, the lens sized, shaped, and positioned within the housing to direct illumination from the light source through the translucent member,
wherein the lens is spaced apart from the translucent member, the lens sized, shaped, and positioned within the housing to direct illumination from the light source through the translucent member, wherein the translucent member forms a surface of the lens.

18. The method of claim 17 wherein arranging the transparent opening comprises:
arranging the transparent opening as a translucent member extending across the transparent opening; and
forming a lens between the light source and the translucent member, the lens sized, shaped, and positioned within the housing to direct illumination from the light source through the translucent member, wherein the translucent member forms a surface of the lens.

19. The method of claim 15 wherein producing illumination of a fingertip comprises:
arranging the light source and the sensor module within a single circuit package; and
disposing the single circuit package relative to the housing to enable positioning the light source and the sensor module adjacent to the transparent opening.

20. The method of claim 15 wherein producing illumination of a fingertip comprises:
arranging a substantially dark transparent member across the transparent opening across the path of light emitted by the light source to minimize illumination of an ambient environment surrounding the optical switch while simultaneously enabling illumination of the fingertip.
